(19) United States
(12) Patent Application Publication
(10) Pub. No.: US 2008/0160940 A1
(43) Pub. Date: Jul. 3, 2008

(54) RADIO ADVERTISEMENT BASED ON RDS

(76) Inventor: Magnus Jendbro, Staffanstorp (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/617,123

(22) Filed: Dec. 28, 2006

(51) Int. Cl. H04B 1/18

(52) U.S. Cl. 455/185.1

(57) ABSTRACT

A mobile station capable of receiving FM broadcasts including RDS information and having means for communicating with a server (205) where the mobile station comprises means (150, 110, 130, 165, 170, 175) for communicating a trigger message based on RDS information from the currently tuned FM broadcast radio station to said server (205), and further comprising means (110, 130, 165, 170, 175) for receiving and displaying a reply message from said server. Also a server may be provided with means for creating and sending a reply message based on the received trigger message.

### FIELD OF THE INVENTION

The present invention relates to the field of radio broadcasting and of using Radio Data System, RDS information to provide an RDS receiver client with enhanced advertisement or other information.

### BACKGROUND OF THE INVENTION

In FM radio applications it is today possible to show “RDS feeds”, which feeds could include localized advertisement. A drawback with this RDS-based information is that it is only text based and no graphics like e.g., radio station logos is included. There is a need to one or more of enhance the capabilities of RDS, enhance uses of RDS and/or to enhance systems that make use of RDS.

The following information fields are normally contained in the RDS data:
AF: Alternate Frequencies. This allows a receiver to re-tune to a different frequency providing the same station when the first signal becomes too weak (e.g. when moving out of range). This is often utilized in car stereo systems.
CT: Clock Time. Can synchronise a clock in the receiver or the main clock in a car.
EON: Enhanced Other Networks. Allows the receiver to monitor other stations for traffic broadcasts.
PI: Program Identification. This is the unique code that identifies the station. Every station receives a specific code with a country prefix.
PS: Program Service. This is simply an eight-character static display that represents the call letters or station identity name. Most RDS capable receivers display this information and, if the station is stored in the receiver's presets, will cache this information with the frequency and other details associated with that preset.
PTY: Program Type. This coding of up to 31 pre-defined programme types—e.g., (in Europe): PTY1 News, PTY6 Drama, PTY11 Rock music—allows users to find similar programming by genre. PTY31 seems to be reserved for emergency announcements in the event of natural disasters or other major calamities.
REG: Regional links. This is mainly used in countries where national broadcasters run “region-specific” programming such as regional opt-outs on some of their transmitters. This functionality allows the user to “lock-down” the set to their current region or let the radio tune into other region-specific programming as they move into the other region.
RT: Radio Text. This function allows a radio station to transmit a 64-character free-form textual information that can be either static, e.g., station slogans or in sync with the programming, such as the title and artist of the currently-playing song.
TA, TP: Travel Announcements, Traffic Program. The receiver can often be set to pay special attention to this flag and, e.g., stop the tape or retune to receive a Traffic bulletin. The TP flag is used to allow the user to find only those stations that regularly broadcast traffic bulletins whereas the TA flag is used to stop the tape or raise the volume during a traffic bulletin.
TMC: Traffic Message Channel. Demands a RDS-TMC decoder.

### SUMMARY OF THE INVENTION

It should be emphasized that the term “comprises/comprising” when used in this specification is taken to specify the presence of stated features, integers, steps or components but does not preclude the presence or addition of one or more other features, elements, integers, steps, components or groups thereof.

Features that are described and/or illustrated with respect to one embodiment may be used in the same way or in a similar way in one or more other embodiments and/or in combination with or instead of the features of the other embodiments.

An aspect of the invention is to provide RDS-based advertisement making use of the full media rich potential of a modern mobile station, such as, for example, the possibility to show advanced color graphics, photo and video images, etc.

According to an aspect, the present invention provides a mobile station capable of receiving FM broadcasts including RDS information and having means for communicating with a server where said mobile station comprises means for forming and communicating a trigger message derived from RDS information from the currently tuned in FM broadcast radio station to said server, and further comprising means for receiving and presenting a reply message from said server.

According to another aspect, the mobile station comprises a trigger message former, capable of extracting advertisement related RDS information from the RDS information received together with the FM broadcast, and being able to create a trigger message derived from said advertisement related information.

According to another aspect, the mobile station also comprises a media rich server IP address lookup table for finding an IP address whereto send the trigger message.

According to another aspect of the invention, a server is capable of receiving the trigger message and returning a reply based on said trigger message.

According to another aspect of the invention, a communications system is provided comprising the mobile station and at least one server of the type mentioned above.

According to another aspect of the invention a method for presenting media rich messages on a mobile station provided with radio data system (RDS) capability comprises the following steps:
receiving an FM broadcast provided with RDS data;
extracting the RDS data;
creating a trigger message derived from the RDS data;
obtaining an IP address to a media rich server;
sending the trigger message to the media rich server;
returning from the media rich server a media rich stream message to the mobile station;
utilizing the media rich stream message in the mobile station;

Another aspect relates to the step of obtaining an IP address to a media rich server includes the step of using a preconfigured list of server IP addresses in the mobile station to find out to which IP address to send the trigger message.

Another aspect relates to the step of obtaining an IP address to a media rich stream server may including the step of creating and sending a query message to an address server, and subsequently receiving an address to a media rich stream server from the address server.

Another aspect relates to the query message comprising information concerning radio station frequency and radio station identity.

Another aspect relates to the query message comprising information concerning mobile station position.

Another aspect relates to the query message comprising information concerning the identity of the base station with which the mobile station currently is in contact.

### BRIEF DESCRIPTION OF THE DRAWINGS

The present invention will be further explained in the following description with the aid of preferred embodiments and accompanying drawings of which:

FIG. 1a shows an overview of a system for enhanced RDS presentations according to a preferred embodiment of the present invention.

FIG. 1b shows a simplified block diagram of a mobile station according to an embodiment of the present invention.

FIG. 2 shows a simplified block diagram of a server for providing media rich streams to a mobile station when triggered by an RDS derived message according to an embodiment of the present invention.

FIG. 3 shows a flow chart describing a method for displaying media rich information triggered from an RDS message, on a mobile station according to an embodiment of the present invention.

FIG. 4 shows a lookup table for finding an IP-address to a server holding the appropriate media rich stream.

### DESCRIPTION

Definition:

The term “RDS” is used to denote any existing system for conveying text information similar to the RDS standard from the European Broadcasting Union for sending small amounts of digital information using conventional FM radio broadcasts. A similar system is, e.g., the Radio Broadcast Data System (RBDS), which is the official name used for the U.S. version of RDS.

For the purpose of the present application the term “media rich server” should be interpreted as a server capable of storing and delivering a message, comprising graphics and/or photographic data. The server may be a so called “streaming server” but it may also be another type of server.

Briefly, the invention relates to methods and devices concerning a mobile station (MS) in a mobile communications network equipped with an FM radio data system receiver and also equipped with means for wireless communication with a server over an internet connection over the mobile communications network. A mobile station is provided with means for extracting radio data system (RDS) information from an FM radio broadcast sent on the frequency that is currently tuned in by the mobile station. The mobile station is further equipped with means for selecting advertisement related RDS information from the RDS information and either provide an advertisement specific code or the complete RDS message relating to the advertisement related RDS information. Further, the mobile station is provided with means for communicating the advertisement specific code or the complete RDS message to a media rich server, which server is provided with means for returning a more media rich stream, elaborating and supplementing the original RDS message, to the mobile station over an internet wireless application protocol (WAP) connection, or over any suitable protocol running over IP/GPRS, e.g., HTTP, or some other connection.

The mobile station further may be provided with means for subsequently utilizing the media rich stream, e.g., by presenting the media rich stream, e.g., in the FM radio application of the mobile station. The media rich stream may, e.g., include the radio logo or offers from local firms. Means may also be provided in the mobile station for showing the media rich stream in other mobile station application user interfaces, when, e.g., the radio application is minimized.

The server may be handled by the radio station, but may also be handled by another entity. One advantage of using RDS information as a tag to get the more rich advertisement message is that the radio station already sends geographically unique advertisements using RDS, such that different messages are sent in different cities, group of cities or geographical areas, depending on the coverage of respective station transmitter.

The invention also relates to a method for presenting media rich messages on a mobile station provided with radio data system (RDS) capability including the following steps:

receiving an FM broadcast provided with RDS data;
extracting the RDS data;
creating a trigger message derived from the RDS data;
obtaining an IP address to a media rich server;
sending the trigger message to the media rich server;
returning from the media rich server a media rich stream message to the mobile station;
utilizing the media rich stream message in the mobile station, e.g., for presentation purposes;

In an alternative embodiment the step of obtaining an IP address to a media rich server includes the step of sending a query message to an address server, and subsequently receiving an address to a media rich server from the address server.

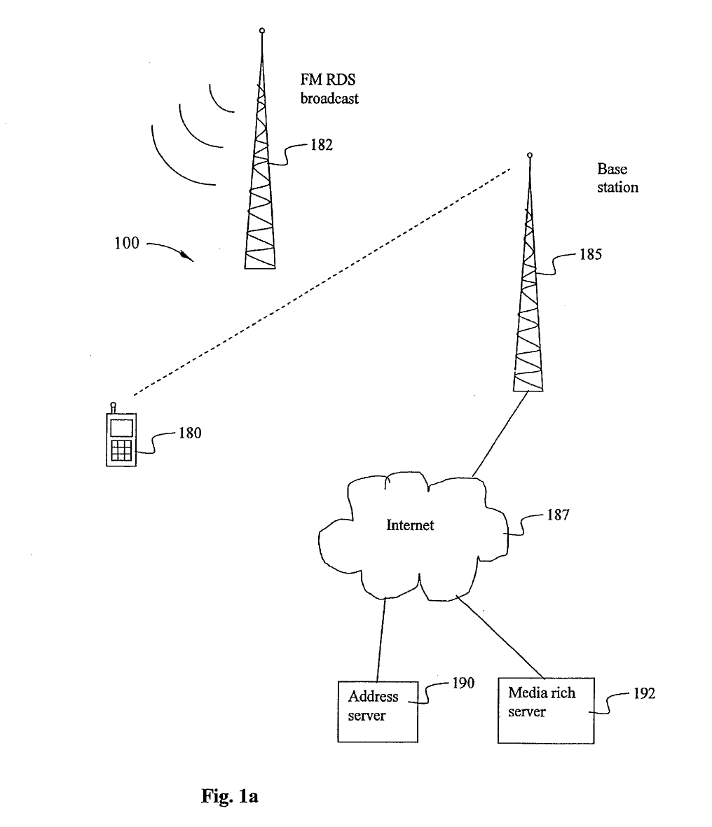

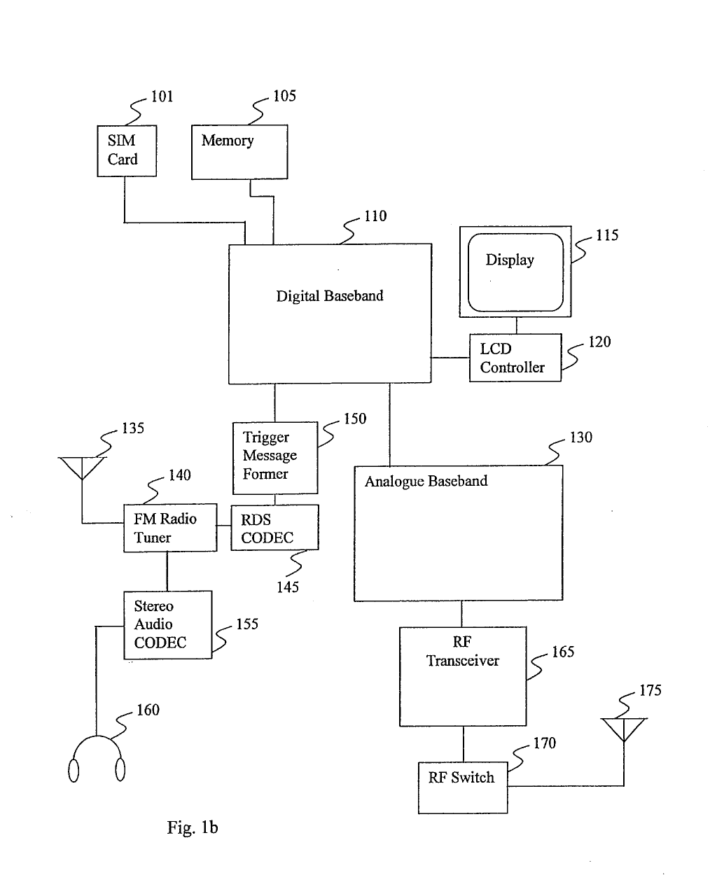

FIG. 1a shows an overview of a system 100 for enhanced RDS presentations according to a preferred embodiment of the present invention. A mobile station 180 receives an RDS broadcast transmission from an FM RDS transmitter 182. The mobile station communicates a trigger message derived from the RDS broadcast transmission to the base station 185 on which it is currently camping. The trigger message is communicated via internet 187 (or another communications connection, link, etc.) to a media rich server 192, which returns a media rich stream shaped, formatted, configured, etc. to enhance the original RDS stream from which the trigger message was derived when presented by the mobile station. In an alternative embodiment the address to the media rich server 192 is retrieved from a dedicated address server 190.

FIG. 1b shows a simplified block diagram of a mobile station according to an embodiment of the present invention, such as, for example, the mobile station 180. The mobile station comprises a mobile communication system antenna 175 connected to an RF switch 170 which switch 170 is connected to an RF Transceiver 165. The transceiver 165 is connected to an analog baseband module 130 for handling the analog portion of the mobile communication.

The mobile station further comprises an FM antenna 135 connected to an FM radio tuner 140 for receiving FM broadcasts including RDS information. The tuner 140 is connected to an RDS CODEC module 145 for decoding RDS messages. The RDS CODEC module 145 is in turn connected to a trigger message forming module 150, which module 150 takes RDS information, selects advertisement related information, and forms a so called trigger message comprising relevant information to be sent to an internet advertisement server. The relevant information may include the complete message or a hash like string generated from the complete message, or another message or message string derived from RDS information. In one embodiment the trigger message is formed to comprise the following information: advertisement message, radio station frequency, radio station name. The trigger message is further processed in the digital baseband module 110 to further include mobile station position information, e.g., current base station identity. The information in the trigger message is then used in the digital baseband module 110 to search a preconfigured list of IP addresses to media rich servers to find the IP address to the media rich server that are to handle the current advertisement media rich stream. The advantage with this arrangement will be explained in the following. Consider a radio channel having for example three stations located in three major cities in a country, city 1 to 3, and sending on two different frequencies; f1, f2, that is, more than one station are transmitting on the same frequency as one of the other stations. With the arrangement of the invention it is possible to have three different servers providing three different advertisement media rich stream messages. This can be used to provide local advertisement for local restaurants or other companies located within the coverage of each transmitter.

In an alternative embodiment the digital base band module 110 is provided with a preconfigured IP address to an address server. The address server is provided with a list of IP addresses of a number of media rich servers, and means for returning the address to the appropriate media rich server as a reply to a query from the mobile station. The query is prepared by the digital baseband module to comprise information concerning radio station frequency, radio station name and mobile station position information.

It might be that there are many addresses—one per station/entity that is included in an advertisement service, making use of the invention. It may also be so that all media rich messages are provided from the same server.

Thus, the media rich server, and when occurring, the address server, is configured to reply to an IP address provided by the mobile station as part of the IP system—i.e., the mobile station includes its own IP address in the packet so the data going back can be correctly routed.

The FM tuner 140 is also connected to a stereo audio decoder module for providing signal for a stereo headset 160.

The mobile station further comprises ordinary modules such as SIM card 101, memory 105, digital baseband module 110 connected to an LCD controller 120 and a display 115.

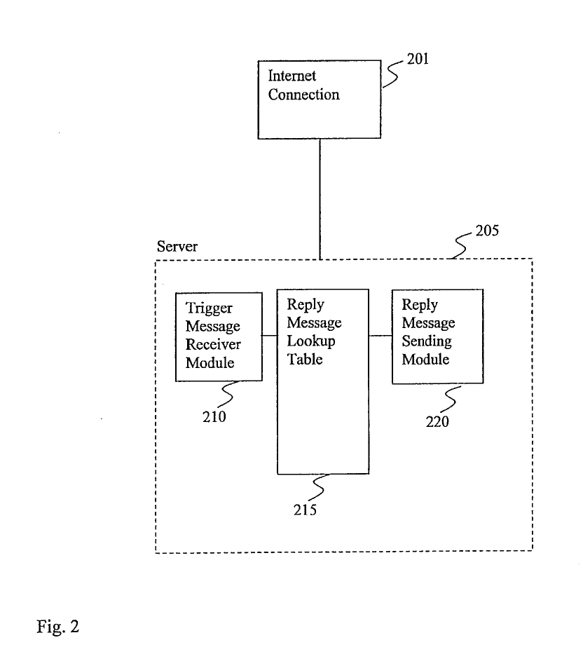

FIG. 2 shows a simplified block diagram of a server 205 for providing media rich streams to a mobile station when triggered by an RDS derived message according to an embodiment of the present invention. To differentiate the server 205 from other servers that may be mentioned in this application the server is sometimes referred to as a “media rich server”, because it handles the returning of media rich streams to the mobile station. The server 205 is connected to the internet via an internet connection module 201. The server 205 comprises a trigger message receiver module configured to receive trigger messages from mobile stations and to identify from which specific mobile station a certain message was sent, and to identify at which radio station frequency the specific mobile station was tuned in at the moment of sending the trigger message. The trigger message receiver module is connected to a reply message lookup table where a reply message is looked up based on trigger message information. The reply message information can be controlled by the radio station and may include radio station logotype, advertisement messages comprising graphics and the like, etc.

The reply message lookup table module 215 is connected to a reply message sending module 220 that sends the reply message to the mobile station that sent the trigger message. The reply message could be any message and the returned data may comprise, for example, text, audio, graphics, video and web links in any combination.

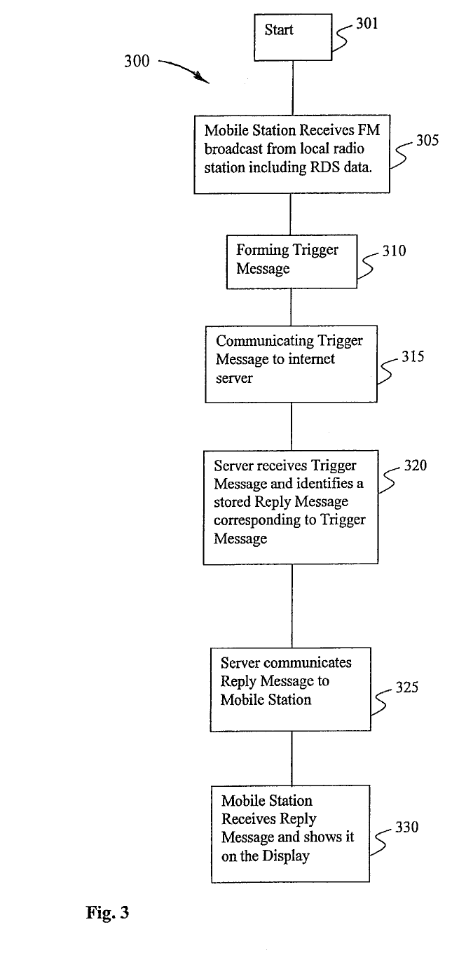

FIG. 3 shows a flow chart 300 describing an exemplary method for displaying media rich information triggered from an RDS message, on a mobile station according to an embodiment of the present invention. The method comprises the following steps that are represented by the illustrated blocks:

At block 301 is the start. For example, the system may be initiated, powered on, booted up, etc.

At block 305 the mobile station receives FM broadcast transmission from local radio station including RDS data;

At block 310 the mobile station forms trigger message derived from RDS data information;

At block 315 the mobile station communicates a trigger message to an internet server arranged to provide reply messages;

At block 320 the internet server receives the trigger message and identifies a stored reply message corresponding to the trigger message:

At block 325 the internet server communicates a reply message to mobile station;

At block 330 the mobile station receives the reply message and shows it on its display 115.

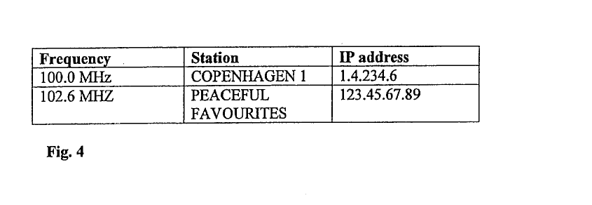

FIG. 4 shows an example of a fictitious table of frequencies, radio stations and IP addresses. It can be seen that the IP address where to send a trigger message derived from an RDS broadcast from radio station “COPENHAGEN 1” on 100.0 Mhz is 1.4.234.6.

It will be appreciated that the flow chart 300 is exemplary of operation of the invention and carrying out the method of the invention. Accordingly, various other steps, procedures, etc. may be used instead of or in addition to the steps and processes that are described above to achieve the desired operation.

As will be appreciated by one of ordinary skill in the art, computer program elements and/or circuitry elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to certain preferred embodiments, it is obvious that equivalents and modifications will occur to others skilled in the art upon the reading and understanding of the specification. The present invention includes all such equivalents and modifications. The described embodiments are provided for explanatory purposes only and shall not be interpreted as limiting the scope of the invention, which scope is limited by the appended claims only.

1. A mobile station capable of receiving FM broadcasts including RDS information and having means for communicating with a server where said mobile station comprises means for forming and communicating a trigger message derived from RDS information from the currently tuned in FM broadcast radio station to said server, and further comprising means for receiving and presenting a reply message from said server.

2. The mobile station of claim 1 comprising a trigger message former, capable of extracting advertisement related RDS information from the RDS information received together with the FM broadcast, and being able to create a trigger message derived from said advertisement related information.

3. The mobile station of claim 1 comprising a media rich server IP address lookup table for finding an IP address whereto send the trigger message.

4. A server capable of receiving the trigger message of claim 1 and returning a reply based on said trigger message.

5. A communications system comprising the mobile station of claim 1 and at least one server of claim 2.

6. A method for presenting media rich messages on a mobile station provided with radio data system (RDS) capability comprising the following steps:
receiving an FM broadcast provided with RDS data;
extracting the RDS data;
creating a trigger message derived from the RDS data;
obtaining an IP address to a media rich server;
sending the trigger message to the media rich server;
returning from the media rich server a media rich stream message to the mobile station;
utilizing the media rich stream message in the mobile station;

7. The method of claim 6 where the step of obtaining an IP address to a media rich server includes the step of using a preconfigured list of server IP addresses in the mobile station to find out to which IP address to send the trigger message.

8. The method of claim 6 where the step of obtaining an IP address to a media rich server includes the step of creating and sending a query message to an address server, and subsequently receiving an address to a media rich server from the address server.

9. The method of claim 8 where said query message comprises information concerning radio station frequency and radio station identity.

10. The method of claim 9 where said query message also comprises information concerning mobile station position.

11. The method of claim 8 where said query message comprises information concerning the identity of the base station which the mobile station currently is in contact with.
